(19) United States
(12) Patent Application Publication
(10) Pub. No.: US 2011/0111225 A1
(43) Pub. Date: May 12, 2011

(54) Extruded Filament Having High Definition Cross-Sectional Indicia/Coding, Microscopic Tagging System Formed Therefrom and Method of Use Thereof for Anti-Counterfeiting of Product Authentication

(75) Inventors: Peter D. Gabriele, York, PA (US); Jeffrey H. Robertson, York, PA (US); Michael S. Flemmens, Glen Rock, PA (US); Matthew G. Weir, York, PA (US); Jeffrey S. Haggard, Cocoa, FL (US)

(73) Assignees: ARMARK AUTHENTICATION TECHNOLOGIES, LLC, Glen Rock, PA (US); HILLS INC., West Melbourne, FL (US)

(21) Appl. No.: 12/299,951

(22) PCT Filed: May 10, 2007
(86) PCT No.: PCT/US07/68706

§ 371 Date: Mar. 2, 2010

Related U.S. Application Data
(60) Provisional application No. 60/799,032, filed on May 10, 2006.

(51) Int. Cl. D02G 3/00; B23P 17/04

(52) U.S. Cl. 428/373; 428/397; 428/402; 29/592

(57) ABSTRACT

An extruded filament is provided having a cross-sectional configuration which permits a cut transverse section of the filament to function as a high definition tagging material, the extruded filament having contained therein along the direction of the longitudinal axis (the axis of extrusion) of the filament a multitude of extruded strand portions, which may be the same or different from one another from the standpoint of composition, visual or forensic effect, and which strand portions provide a multitude of pixel-like portions within a cross-sectional portion of the filament, which multitude of pixel-like portions, when taken together, comprise at least one pre-selected degree of identification whereby the tagging material may be differentiated or identified based on at least one degree of identification. A cut fiber or microparticle formed from the filament may be used to authenticate a product when used in association with the product.

### BACKGROUND OF THE PRESENT INVENTION

The present invention is directed to a microscopic tagging system for security identification, product source identifier and/or information storage.

Global counterfeiting costs are increasing yearly, and are estimated to exceed $1.3 trillion on a yearly world-wide basis. Consumer areas particularly susceptible to counterfeiting include, by way of example, apparel, OEM parts (automobile or aerospace), electronics, communication equipment, toys, off-shore goods, medical devices and pharmaceuticals, packaging technologies, secure and financial documents. For example, up to 10% of pharmaceuticals are estimated to be counterfeit.

The increase in counterfeiting is the result of , for example, the global spread of capital, the existence of a porous supply chain, declining or ineffective intellectual property enforcement, the growth of illegitimate commerce, and importantly, the lack of an effective means to identify products (either authentic or counterfeit) upon entering the supply chain. This increase in counterfeiting results in lost tax revenues, loss of brand equity, and the potential for enhanced risk to the purchasing public and/or user of the counterfeit product. This has also required significant effort and expense on behalf of various governments and trade organizations.

It is thus desirable to provide a method by which such products may be authenticated by use of authentication means which is compatible with other layered technology approaches, comprises a proven technology migration path to stay ahead of criminal elements, uses technology that provides ease of authentication, uses a technology that is difficult to replicate; and enables seamless integration into existing processes. The use of such technologies provides product surety, brand protection and risk mitigation to be achieved.

It is also desirable to provide verification tagging means which can ensure product integrity throughout the supply chain, which tagging means can be used either externally to the target product (either on the product, or on packaging used with the product, or on containers holding the product), or integrated within the target article (as appropriate). It is further desirable for the tagging means to be able to be used without adversely impacting the appearance, performance or utility of the target product.

For example, when used to authenticate a pharmaceutical product, it would be desirable for the tagging means to be able to be used to “tag” packaging for pharmaceutical products, and/or be used to “tag” the pharmaceutical product itself so that the authenticity of the product or packaging may be readily verified. It is thus desirable for the tag to include embedded information such as manufacturing data, company source identifiers, lot numbers, product name, etc.

In addition, the safety of agricultural/food products has recently come into question, placing the ability of determining the source of such products at a premium. It is, for instance, important to be able to verify the source (either by country of origin, specific farm, or growing locale) of agricultural or food products in the event of the sale of contaminated products which may cause harm to consumers of such products, whether animal or human consumers. It is also important for the manufacturer and/or distributor of such products to be able to confirm that their respective product(s) is or is not the source of such contamination for purposes of confirming potential liability and/or taking steps to stop sale or production of contaminated products to limit further use of or contact with contaminated products by the public.

### SUMMARY OF THE PRESENT INVENTION

The present invention is accordingly directed to the use of micron-sized tags to verify ownership or source of a product by a variety of means. Such ownership or source may be determined by tag identity in a film, coating, or composition, or on or in any other product (such as food or pharmaceuticals) where it may be important to verify source or any other characteristic of the product (such as exposure to the environment, expiration date, product lot number, manufacturer name, geographic origin, etc.).

Microscopic tagging materials are known as disclosed in U.S. patent publication Nos. 2003/0236219, 2004/0034214, and 2005/0129454, as well as U.S. Pat. No. 6,951,687. These publications and U.S. patent disclose methods of tagging wherein tagging is determined by, for example, the shape or other physical character of the tagging material, generally relating to the physical form of the tagging material, such as by the use of holes or grooves in the tagging material.

It is also known as taught by U.S. Pat. No. 4,640,035 to employ island-in-the-seas technology to provide particulate coding material which may be used to identify the source of a product based on information contained in a cut, transverse section of the material, including a word, number, mark or the like, including the use of multiple colors in respective island portions (column 1, lines 45-57). Island-in-the-sea bicomponent polymer composite fibers are also disclosed in U.S. Pat. Nos. 3,692,423 and 3,725,192.

It has also been theoretically proposed that a particular configuration of islands in island-in-the-sea technology used in the production of bi-component fibers may be used in the prevention of counterfeiting by providing a complex identification mark recognizable only under a microscope. Baker, I F J, pp. 28-42, June, 1998. However, the use of cut portions of such fibers as microtags is not taught.

However, it has been found desirable to provide enhanced levels of security for the tagging material to avoid misuse or counterfeiting of the material, as well as be able to incorporate within the tagging material high density embedded information that is otherwise visually covert but which, under magnification, serves to identify the product by physical, visual or chemical means, by name or by geographic or manufacturer source.

In particular, there is a need to provide a means to impart a wide variety of information pertaining to a product by covert (microscopic) means which is only readable under magnification of from, for instance, 50-200×, and which provides more information pertaining to the product or the source of the product than can be provided solely by use of modification(s) to the shape of the product such as by the use of holes or grooves in the product, or which is otherwise possible from previously described island-in-the-sea technology.

In this regard, there is thus provided an extruded filament having a cross-sectional configuration which permits a transverse section of said filament to function as a high definition tagging material. The extruded filament comprises a multitude of extruded strands which, subsequent to extrusion thereof, are combined to form a unitary composite filament. In cross-section, the multitude of strands enable a multitude of pixel-like portions to be formed which, depending on the property of each pixel, enable an unlimited variety of pre-selected informational or identifying indicia to be formed in the cross-section of the filament by varying, for example, visual, physical or chemical properties of each strand (and the resulting pixel) during formation of the filament. The individual strands, and hence the resulting pixels, are of such small dimension and large in number as to enable an extremely high informational density to be provided within the cross-section of the filament over and above that previously contemplated by the prior art.

Importantly, the resulting high informational density which is possible enables pre-selected indicia/coding to be provided in the cross-section which is unlimited in shape or design despite the microscopic size of the filament cross-section, and may include alpha-numeric indicia such as words, letters or numbers, a variety of symbols, graphic depictions such as company logos, abstract artwork, etc. The present invention accordingly constitutes a significant advance in the art of covert product marking for purposes of anti-counterfeiting, product verification and/or authentication, etc.

### BRIEF DESCRIPTION OF THE DRAWINGS

FIG. 1 is a view of microscopic tagging material of the present invention under a magnification of 200× comprised of a multitude of pixels which form a product identifier code formed therein.

FIG. 2 is a view of microscopic tagging material of the present invention having a design formed therein under magnification of 200×.

FIG. 3 is a top view of a high definition distribution (picture) plate used to form a filament whose cross-section is that of FIG. 1.

FIG. 4 is an exploded view of a spinnert assembly for use in the present invention.

### DETAILED DESCRIPTION OF THE PRESENT INVENTION

The present invention is directed to an extruded filament having a cross-sectional configuration which permits a transverse cut section of the filament to function as a high definition tagging material, as well as tagging materials formed therefrom, methods of use thereof, and a method of production thereof.

The extruded filament of the present invention comprises a multitude of strands which, when combined together after being extruded, form a unitary composite filament which, when viewed in cross-section, includes a multitude of pixel-like portions corresponding in number to the number of strands extruded to form the filament. At least a portion of the individual strands (and hence the pixel-like portions) differ from one another from the standpoint of composition, visual, physical or forensic effect to the extent necessary to provide the resulting pre-selected indicia or coding which is desired.

The multitude of pixel-like portions, when taken together, comprise at least one degree of identification such that a tagging material formed of cut transverse sections of the filament may be distinguished or identified based on the at least one degree of identification.

The tagging material of the present invention may advantageously be provided with additional levels of identification security by means such as chemical composition (such as the composition of the extrudable material used to form the tagging material), elemental doping of such extrudable material, functional properties, physical configuration, and combinations thereof.

For example, when multiple (two or more, possibly three or more) levels of security are employed, morphology or other identification characters (such as numbers, letters or symbols formed by the collective effect of the pixel-like portions), may be one level of security, while “polymeric fingerprinting” may be a second level of security in the tagging material. An optional third level of security may be, for example, “elemental fingerprinting” of the polymeric material.

Alternatively, “elemental fingerprinting” may be a second level of security, with the polymer composition being an optional third level of security. The tagging material may, for example, be admixed with any material having rheological properties in the fabrication of a coating or adhesive composition without detriment to the expected physical character of the material to be tagged. Additional levels of security such as functional analysis may also be provided as discussed below.

As discussed above, it is frequently desirable to be able to determine the source and/or identity of products or materials either within the relevant channels of trade as the product is being shipped and/or at the point of use by the end user. Exemplary of such products are hydrocarbon fluids, foodstuffs, pharmaceutical compositions, printing ink, adhesive compositions, security documents, luxury goods, consumer products generally, packaging, financial instruments, etc. For example, it would be desirable to be able to confirm the authenticity of a pharmaceutical product during shipment (given the ease by which pharmaceutical packaging may be duplicated), with the end-user (the pharmacy) conducting additional authenticity verification upon receipt. Under such circumstances, it is further important that the means by which such materials are tagged for identification be unobvious to the naked eye, and be only viewable/readable under magnification (such as 50-200×) and/or under special conditions which make the relevant indicia/coding visually readable but which indicia/coding is otherwise normally invisible even under magnification.

Verification at low magnification using shape analysis of a tagging material is one method which has been proposed by which such tagging may occur, as discussed in the above patent publications. However, despite the fact that microscopic-sized tagging particles are singularly invisible to the naked eye, shape analysis is not foolproof. Potential counterfeiters can easily copy the shape of such tagging materials and incorporate identical or substantially identical tagging materials into counterfeit compositions.

It has thus been found to be advantageous to avoid relying principally on the shape of the microtag as an authenticating characteristic, and to use additional “levels” of security or informational indicia to maintain the desired level of confidence in anti-counterfeiting security as to the determination of identity and/or source of the tagged material.

It may also be advantageous to provide tagging means which is functional in character. That is, it may be desirable for the tagging means to also indicate extent of exposure, if any, to deleterious substances such as oxygen, or to establish the “shelf-life” of the tagged material, which may be important with respect to the use of drugs or pharmaceutical compositions. It may also be advantageous to confirm exposure of the product or material to heat, UV light, radiation, etc.

As noted above, non-shape reliant levels of security as to the tagging material can be provided based on a compositional analysis of the tagging material. Such compositional analysis can occur both by means of the basic composition of, for example, the polymeric material which forms the tagging material, as well as any elemental doping of the polymeric material that is undertaken.

For instance, when a specific polymer blend and/or homo-, co- or terpolymer composition is employed as the extrudable material, the identification of the blend or homo-, co- or terpolymer can be confirmed by means of FTIR (infrared analysis) using the infrared signature or other conventional polymer analytical technique. As to the elemental doping aspect of the present invention, this additional level of identification can be undertaken by means of, for example, electron dispersive analysis or other suitable analytical technique which determines the presence of elemental ions.

Exemplary elemental metals which may be employed to dope the extrudable composition which forms the tagging material. Such materials include but are not limited to elemental iron, tin, lead, platinum, gold, etc., as well as oxides thereof. The elemental material may also be used in the form of fine particles embedded within the tagging material. Such materials may also be doped, co-extruded with a polymer or with another metal, or used alone. A variety of ceramic materials may also be employed in the same manner as the extrudable material.

A variety of polymer materials may be employed as the strand portions of the extrudable material, as the identity of the polymeric material is generally not critical to the present invention, unless, of course, a specific polymer composition is required for a specific end use. However, it is important for the physical properties of the material to be compatible with the material to be tagged. For instance, if the tagging material is to be added to a composition (such as a polymeric composition) for tagging purposes, the tagging material must be inert in the composition. This is particularly important for drug and pharmaceutical, as well as food and agricultural, end uses.

If the tagging material is added to the composition prior to any anticipated processing thereof, the tagging material must be able to maintain physical and dimensional stability under the processing conditions. That is, it might be necessary to employ a tagging material which has a higher melting point than any anticipated processing temperature that may be employed.

Polymeric materials that may be used to form tagging materials that have physical stability at elevated temperatures include but are not limited to fluoropolymers, polyamides, liquid crystal polymers, polyamideimides, polybenzimidazoles, polyimides such as polyetherimides, polyketones such as polyetheretherketones, polyphenylene sulfides, polysulfones, polyethersulfones, polycyclohexane dimethyl terephthalates, and polycyclohexylene dimethylene terephthalates. As the melting properties of the above polymers vary, the choice of which polymer to use would be determined by the anticipated temperature to be encountered during any processing of the material to be tagged, as well as the intended end use of the material. Such a determination is well within the capability of one of ordinary skill in the art.

To the extent that high temperature properties are not required, a variety of additional polymers may be employed. Such polymers include but are not limited to polyesters, polyethers, polyolefins, thermoplastic polyimides, polycarbonates, polyacrylics, rubbers, polystyrene, polyvinyl acetate, polyvinyl alcohol, polyvinyl chloride, etc. Again, the above listings are merely exemplary and not intended to be all-inclusive by nature.

The noted polymers need only be acceptable for use in the formation of a composite unitary filament as described above to be suitable for use in the present invention.

Again, while the above authentication methods may be used with advantage, the present invention provides means by which a significant advance is achieved in providing high definition informational or/or authentication indicia/coding within a microscopic size tagging material not heretofore known in the relevant art.

As discussed above, it has been found to be most desirable in accordance with the present invention to form a tagging material in the form of a transverse cut section of a polymeric filament having a pixelated cross-sectional configuration—i.e., wherein the filament comprises a composite or unitary filament formed from individually extruded strands of pre-determined cross-sectional size such that the pixel-like portions in the cross-section of the resulting filament are similarly sized (if not generally made even smaller due to the drawing of the filament upon being extruded) to provide an extremely high density of pixel-like portions over the cross-sectional area of the filament (and of the tagging material cut therefrom).

The present invention thus enables a high definition pixelated filament product to be provided, which can be cut transversely a multiple number of times to yield a multitude of microscopic tagging materials each having a cross-sectional portion which is capable of bearing high definition identifying or authenticating indicia due to the high density of pixelated portions present therein. Multiple pixel portions may also be separately extruded within a matrix portion (such as to provide an exterior cladding portion), to be combined to form a single filament. The filament can be cut to form the requisite tagging materials.

Advantageously, the individual pixel portions of the extruded filament have a size within the range of 0.0001 to 50 microns, preferably 0.001 to 50 microns. Pixels of a size of 10 microns or less, such a 1 micron or less, may be used with advantage. A multitude of pixel portions are present in the cross-section of the extruded filament. While the number of pixel portions may vary depending upon the end use contemplated (such as the complexity of any indicia required in the cross-section of the filament), it has been found advantageous for the number of pixel portions to range in number from 2000 to 150,000 per cross-sectional area of the filament, preferably from 5000-20,000 in number. A number of pixels in the range of from 20,000 to 60,000 has been found, for example, to enable the formation of a virtually unlimited variety of extremely high definition indicia within the cross-sectional area of the filament. The upper limit employed is generally determined by practical aspects of the invention, such as the cross-sectional dimension of the extruded strands to form the composite unified filament, the size of the distribution plate used in the extruder, etc. Thus, in general, the composite filament of the present invention will comprise at least 2000 pixels, preferably at least 5000 pixels, each being a maximum width of 50 microns, preferably 10 microns or less.

The use of a multitude of pixels in the filament enables high definition indicia to be provided within the cross-section of the resulting filament, thus enhancing the security and/or the informational aspect of the present invention. This enables an unlimited variety of indicia (alpha, numeric, hiratic, geometric, or other symbology) to be employed for purposes of authentication or information retrieval merely by modifying the properties of the extruded strands, such as, by example, the respective colors of the strands by use of colorants, dyes, pigments, etc. The ability to provide high definition indicia enables distinct authentication and/or coding means to be present despite the micron-size of the microtags, an advantage not heretofore taught or recognized by the prior art.

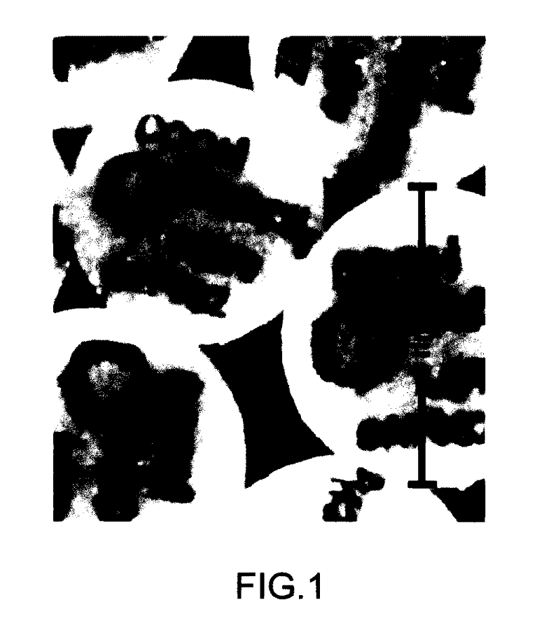

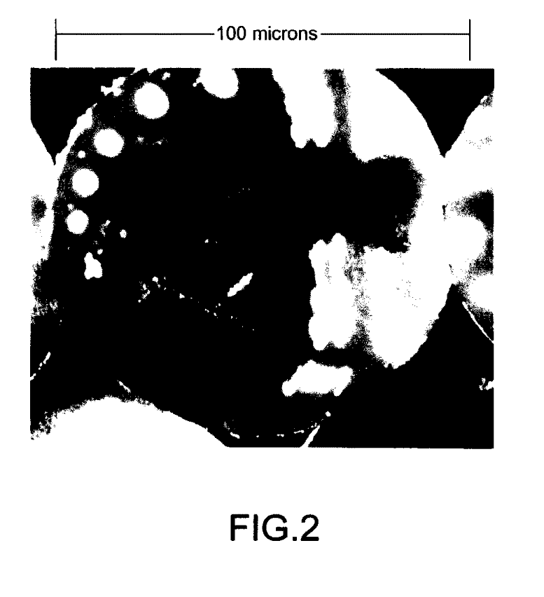

An exemplary authentication design formed in a microtag formed in accordance with the present invention as a cut segment of the extruded filament is depicted in FIG. 1, which cross-section identifies both the formula of a drug and manufacturer lot number. The microtag of FIG. 1 has a width-wise dimension of approximately 120 microns, and a thickness of approximately 30 microns. FIG. 2 depicts a microtag produced in accordance with the present invention having a width of 100 microns (the width of a human hair). FIG. 2 confirms that highly detailed artwork (in this instance a picture of a fish) can be produced in accordance with the present invention within the cross-section of the microtag.

The extrusion technology required to produce such extruded filaments is known to one of ordinary skill in the art. For instance, extrusion technology which may be employed to produce such filaments includes, but is not limited to, the extrusion technology described in U.S. Pat. Nos. 5,162,074; 5,344,297; 5,466,410; 5,533,883; 5,562,930; 5,551,588; 5,575,063; 5,620,644; and 6,861,142, each herein incorporated by reference in their entirety.

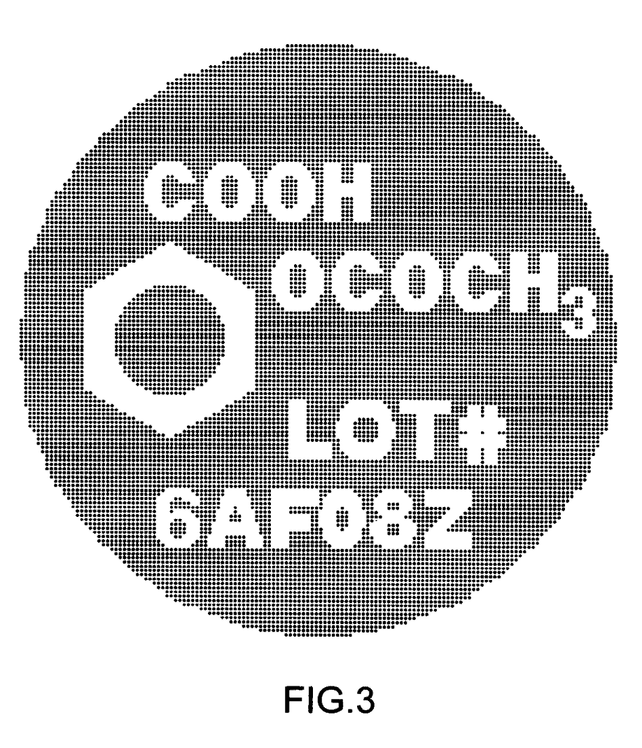

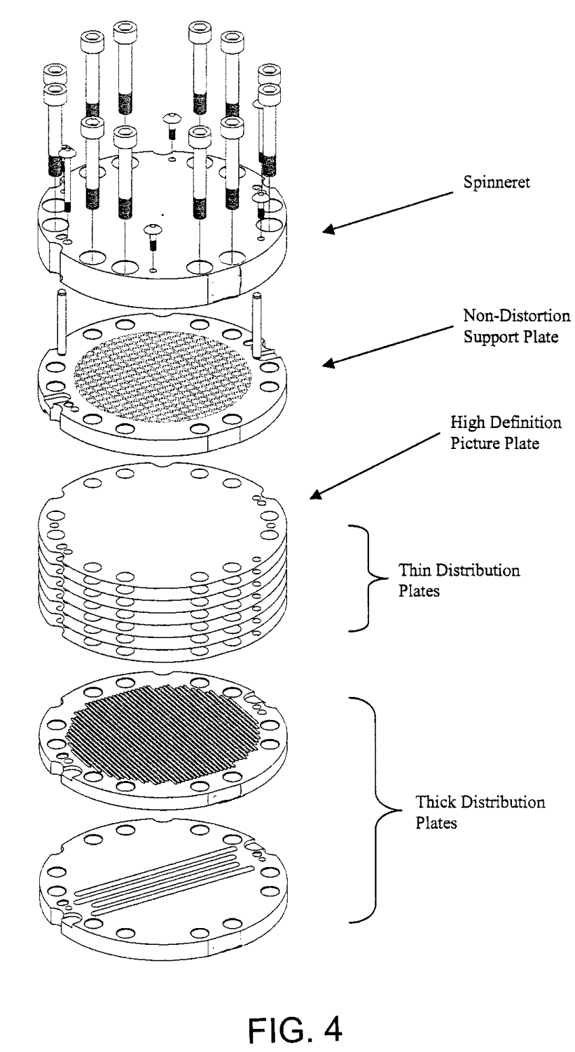

More specifically, as shown in FIG. 4, at least two extruder feeds (not shown) feed separate flowable polymer streams to a series of thick distribution plates which serve to divide the polymer feed into increasingly finer feed streams. The extruders feed flowable polymer streams (which are of differing character, either by color or physical property as discussed herein to enable some type of differentiation to occur in the final filament) to the rear of the first thick distribution plate. The polymer streams flow through the series of thick distribution plates and into the assembly of thin distribution plates. The polymer feeds then flow into the high definition distribution (picture) plate (also depicted in FIG. 3), whereupon the respective polymer streams are mixed, blocked or unblocked so as to obtain the desired design or differentiatable indicia corresponding to the respective design/indicia of the plate (and desired in the final filament). Polymer streams which pass through the high definition (picture) plate then also pass through the non-distortion support plate whose purpose is to minimize or avoid distortion in the design or indicia in the final filament. The non-distortion support plate accomplishes this result by being sufficiently dimensionally stable to resist distortion caused by polymer pressure backflow during extrusion. The polymer streams which pass through the non-distortion plate maintain the same orientation as when exiting the high definition plate. Multiple strands of polymer (corresponding to the number of holes in the high definition plate) exit the non-distortion plate to be collected and combined in the spinneret in order to form the composite filament. The filament which exits the spinneret typically has a diameter of from 200 to 750 microns, and may be drawn down (made thinner) by a ratio of from, for example, 5:1 to 10:1, depending upon the type of polymer being extruded, in order to achieve the desired diameter for the filament product (typically on the order of 100-120 microns). The plates depicted in FIG. 4 are typically about 7 inches in diameter, although the size of the plates is not critical to practice of the invention.

By way of example, a filament comprised of 60,000 pixels may be provided by use of a circular high definition distribution plate having 60,000 holes of an appropriate dimension in relation to the size of the distribution plate. Such holes may be aligned on the plate in parallel rows, with the rows with the largest number of holes having 280 holes or so. For example, a square distribution plate having parallel rows of 280 holes yields 78,000 holes. It is generally difficult to provide a distribution plate having such a large number of holes by mechanical means. Hence, it may be advantageous to employ a distribution plate having the requisite number of holes which are formed by photochemical etching or laser drilling in order to enable the desired authentication indicia to be provided during the extrusion process. Such a distribution plate may be used to form a filament by extrusion of multiple strands constituting the respective pixels which are combined after extrusion by conventional extrusion technology into a single composite filament.

FIG. 3 depicts a circular high definition distribution plate used to form a filament having the cross-sectional configuration of the microtag of FIG. 1, with the plate having 21,000 holes (each ultimately corresponding to a pixel in the resulting filament). The plate of FIG. 3 is typical of a high definition plate that may be employed in the assembly of FIG. 4.

The desired indicia may be formed during the extrusion process by blocking/unblocking the appropriate holes in the high definition distribution plate so as to form the desired number of pixel portions either separately or within a matrix portion. The blocking/unblocking enables a pre-selected indicia/code to be formed by use of pre-selected extrusion feeds from multiple extruders having separate feed pump means which yield the desired pre-selected indicia/code upon formation of the filament. In FIG. 3, the shaded area would receive a different color polymer feed than would the other lighter area of the distribution plate so as to form the desired pixel pattern in the extruded filament.

Authentication indicia may be formed having a variety of colors or, by way of further advantage, a mixture of colors resulting in custom color patterns. Such color patterns may be provided, for example, by use of polymeric compositions of the three primary colors and the color white, which colored polymeric compositions are fed by means of four separate extruders via separate pump means to the distribution plate. By blocking the appropriate holes in the high definition distribution plate, the respective colors can be mixed or matched to yield different color density, etc. for the desired indicia/code (such as letters, numbers, or designs) formed from the pixels. Due to the high definition provided by the high pixel density in the extruded filament, the use of various combinations of such colors (or other colors as may be deemed desirable) enables high quality “artwork” to be produced within the cross-section of the extruded filament and hence, in the cross-section of the resulting cut fibers and/microparticles formed therefrom. While the use of primary colors is discussed above, any color or colors may be employed in the respective polymer feeds.

The separate extruders can also be employed to extrude mixtures of different authenticating components, such as, for example, multiple frequency/radiation-responsive components into the extruded filament as described below.

Typically, the filament which is formed may have a cross-sectional dimension of 1 to 5000 microns, and generally may be as small as 1000 microns, and preferably ranges from 30-1000 microns, such as from 200-500 microns. The filament may, after extrusion, be subjected to sufficient draw down to reduce the cross-section dimension as desired such that the tagging material formed by transverse cutting of the filament has a maximum width dimension of desired magnitude, such as, for example, from 100 to 120 microns in diameter.

Due to the fact that the number (density) of the pixel-like portions in the cross-sectional area of the filament is so large, and given the fact that the visual and/or physical effect of each strand used to form the filament may be specifically customized to provide a separate visual, chemical or physical effect, it has been found that the number of possibilities regarding the type of identifying, authenticating and/or informational indicia/coding is substantially endless. Indeed, high definition letters, numbers, words, formulae, art work, designs, etc. may be incorporated into the cross-section of the filament. By practice of the present invention, the microscopic size of the cross-sectional dimension of the tagging material does not limit the degree to which authenticating or informational indicia may be provided within the material, whether, words, numbers, letters, art work, or the like.

Of course, the coding aspect of the present invention need not be limited to such kinds of informational indicia. Indeed, exemplary coding also includes functional coding embodiments such as the use of chemical compositions embedded within the pixel portions which react with or are stimulated by applied stimulating means such as specialized radiation means, whereby the coding does not (when stimulated) result in the formation of a letter, number or design coding, but instead presents an effect resulting from the applied stimulation. For example, a general florescence effect resulting from applied radiation constitutes an acceptable coding, irrespective of the fact that the coding is not visible to the naked eye absent the required stimulation, and irrespective of the fact that the visual effect does not form a specific indicia such as a letter, number or symbol.

Similarly, the variety of end-uses of the tagging material of the present invention are endless. For example, when employed with foodstuffs or pharmaceutical compositions, the tagging material must be non-toxic and suitable for human consumption As such, any typical food- or pharmaceutical-grade polymeric materials may be so employed. Food- or pharmaceutical-grade polymers are well-known to those of ordinary skill in the art.

For instance, exemplary food-grade materials include but are not limited to acrylic acid/acrylamide copolymer, adipic acid, carboxymethylcellulose, carnuba wax, casein, cellulose acetate, cellulose acetate phthalate, chitan, chitosan, corn syrup solids, Dammar, ethyl cellulose, gelatin; paraffin wax, pectin, polyacrylamide, polyethylene, polyethylene wax, polyethylene (oxidized), polyvinyl acetate, polyvinyl alcohol, rice wax, soy protein, wheat gluten, whey protein, and zein.

Exemplary pharmaceutical-grade materials include but are not limited to polyethylene, polyacrylate, cellulosic polymers, carboxymethylcellulose, ethylcellulose, methylcellulose, hydroxyethylcellulose, hydroxypropylcellulose, hydroxypropyl(methyl)cellulose, cellulose acetate, polyglycolide, poly DL lactide, poly lactic acid, poly (ε-caprolactone), algenate, poly dextrin, dextrate, docusate sodium, xanthan gum, gums, polyethylene glycol, polyhydrocarbon waxes, paraffins, polyglycols, providones, proteins, butylated hydroxytoluene, carbomer 934 or 974, etc.

Animal feed-grade materials include but are not limited to alginic acid, Aqualon 7LF, N-7, N-10, N-14, N-22, N-50, and N-100; Edicol, Ethocel Standard 4, 7, 10, 20, 45 or 100 Premium, corn protein, casein, gelatin by-products, soy protein, lignin sulfonate, cellulose, chitosan, chitan, acrylamide-acrylic acid resin, beeswax, carnuba wax, etc.

Previously-discussed U.S. Pat. No. 4,640,035 discloses particulate coding materials comprised of a transverse section of an assembly of elongated elements such as synthetic or natural fibers. The assembly can be produced by, for example, combining pre-existing filaments such as by twisting, or by co-extrusion through a die or spinneret, followed by a draw down step to provide filaments of the desired size, and then transverse sectioning or cutting. The patent teaches that such particulate coding materials may be incorporated into drugs or pharmaceuticals to permit rapid identification in the emergency treatment of overdoses.

However, it has been found possible, instead of adding the particulate material to a drug or pharmaceutical composition for identification purposes, to incorporate the drug or pharmaceutical into the particulate coding material itself such that the drug or pharmaceutical would be self-authenticating. For example, the drug or pharmaceutical may be compounded into an edible or bio-compatible polymer which is then formed into a filament in accordance with the present invention. The filament may then be sectioned or cut into a desired size for use in a pharmaceutical composition together with any desired excipients, fillers, etc. The sectioned or cut pieces may be compounded into a solid tablet, incorporated into a capsule, or administered in liquid form (such as in a syrup, suspension, dispersion, etc.).

The tagging materials of the present invention provide a low cost, simple, efficient means for source and/or identity verification. Desirably, the requisite polymer and elemental analysis can be accomplished with conventional laboratory equipment.

The tagging material of the present invention can be employed in many ways. For example, a desired composition of the tagging raw material (such as a specific homo-, co- or terpolymer) can be doped with a specific elemental material. Such doping would generally occur by admixture of the doping material with the polymeric material in melt form. The tags can then be produced from the doped composition in the desired shape by suitable means such as extrusion or melt-spinning of fibers formed of such doped polymers as discussed above. The respective tags may then be cut from the extruded or spun material to the desired dimension or thickness.

By way of additional embodiments, tags which incorporate at least one active drug component therein may have formed on the surface thereof by co-extruding a cladding or surface layer thereon which includes one or more antibodies which are specific to an antigen in the body of the patient. In this way, a pharmaceutical effect can be achieved which may be targeted toward a specific aspect of desired treatment upon admissible of the tagging material to the patient. The size of the tagging material can be selected to optimize administration. The selection of such antibodies in relationship to the corresponding antigen is within the ability of one of ordinary skill in the art.

The size of tags of the present invention may vary with the end use. The tags may be in the form of particulates, disks, fibers, filaments, etc. As such, the particular size, shape and/or configuration of the tags is not particularly important or critical, and can be easily tailored to the desired end use. Mixtures of tagging materials of different aspects ratios (e.g., fibers plus disk-shaped microtags) may also be used with advantage, particularly if each type of tagging material bears different information or provides a different level of authentication (such as a physical or chemical response).

The tagging material of the present invention will generally be of such size such that its presence is not readily visually apparent in the material to be tagged such that its use is covert. Indeed, a magnification of from about 50 to 500× is generally required to both visually identify the presence of the microtag and to decipher any visually discernible indicia formed thereon.

The size of the tagging material is desirably within the range of 1 to 5000 microns in width, such as a range of 10 to 3000 microns. Such particles would normally have a lesser dimension or thickness such that the particles have an aspect ratio of 1:30 to 10,000:1, preferably 1:20 to 5000:1, based on the ratio of thickness (length) to width of the particle. The aspect ratio of the tagging material can vary widely, as both disc-shaped as well as fiber or filament-shaped tagging materials are contemplated according to the present invention. To the extent that the shape of the tagging material is to be the first level of security, it is thus desirable for the material to be of such dimension that a particular shape may be practically determined. If used in a fiber or filament, the fiber or filament may be used as a “tag” when used to form a non-woven or woven material such as a web, sheet or fabric. Such microtags, when in the form of disks, will generally range in thickness from 10-20 microns, and being from 90-150 microns in maximum width-wise dimension.

For example, a disk-shaped type of tagging material may be used with advantage, with the disk being of any desirable configuration such as triangular, trilobal, circular, rectangular, square-shaped, etc., with the ultimate shape being determined by the configuration of the extrusion die used. Such disc-shaped tagging material may be formed, for example, by transverse cutting of the above-described filament. To aid in the security determination, the disk may have incorporated therein any number of additional security features as discussed above. It is apparent that an infinite number of combinations of “codes” can be imparted to the tagging material, especially if additional levels of security such as polymeric composition and elemental analysis are employed. For instance, the tagging material may include a variety of pre-selected extruded symbols which serve as identifiers, such as numbers or letters, or a differentiable color pattern. Of course, a custom color blend may also be formulated which in itself serves as a “code” within the tag.

The thus-produced tagging material can be formulated into a composition such as a pressure sensitive adhesive system to “tag” the system as to source and/or identity. Alternatively, the tagging material may be added or applied to materials to be tagged (such as foodstuffs, pharmaceuticals, liquid compositions, etc.) by aerosol, coating extrusion, and spraying applications, etc. In such an instance, the tagging material could be conveyed in the form of a dispersion together with an inert liquid such as water. The microscopic size of the tagging material lends itself particularly well to application in the form of an aerosol, with the microscopic size also enhancing the propensity of the material to adhere to the material to be tagged.

By way of further example, it may also be desirable to incorporate tagging materials into the printing ink of ink-jet printers in an attempt to reduce counterfeit product manufacture, or reduce counterfeit products by using an ink in the printing of such bar codes that contains the tagging material of the present invention. The size of the tagging material used in such inks will be customized to function satisfactorily during the printing, with such sizing being within the skill of one skilled in the art. The tagging material may be used in such inks in an amount of up to about 5% by weight. Sufficient tagging material is employed to provide the requisite degree of tagging without adversely affecting the function of the ink during printing.

The product may also be used in a coating for a drug tablet or on packaging for pharmaceuticals to ensure authenticity of the product.

It is also within the scope of the present invention to provide a tagging material that is chemically or functionally “active”—i.e., the tagging material may undergo either a physical or chemical change when exposed to a pre-determined condition or conditions.

For example, it may be desirable to provide the tagging material with photo-responsive chemistry that will provide a visual effect upon exposure to light such as may be provided by a photocopy machine. Copies made by such a photocopy machine will accordingly be made subject to resolution disruption of the copy. This would enable the photocopy to be identified as a photocopy as opposed to an original. It is thus not necessary for the indicia/code to be visible to the naked eye even under magnification, but the indicia/code may be such that it only becomes visible under specific conditions, such as when exposed to certain radiation, etc.

By way of example, photochromic agents, phototropic agents, fluorescent agents, as well as near-, mid- and far IR agents may be employed in printing inks in such a context. Desirably, the presence of such materials in the printing ink would result in a photonic reaction to the emitted light source during copying, which would disrupt the formal of a normal image during copying. That is, the fidelity of image capturing is compromised, as the resulting photocopy is rendered unusable in the form produced.

Such agents, in order to produce a photonic reaction, can be easily matched to the specific light source used in the photocopy machine. Such photonically-active materials are well known to those of ordinary skill in the art. For instance, a number of suitable photochromic agents are available under the Reversacol product line of James Robinson. James Robison also markets a line of fluorescent agents, including Fluorescent Yellow GN, Fluorescent Yellow R, Fluorescent Yellow AA 216, Fluorescent Yellow AA223, Fluorescent Yellow FGPN, Fluorescent Yellow Yellow 4, and Meratime Brilliant Yellow 8G.

It is also possible to provide multivariate and/or frequency specific fluorescent features in the tagging material. The tagging material of the present invention is capable of including a wide variety of alpha/numeric indicia within the cross-section of the cut filament (thereby providing a tagging marker having such indicia on each exposed face of the marker). However, in order to maximize the covert aspect of such tagging indicia, the pixel portions may be provided with fluorescent or active photochemical materials as discussed above which provide a selective and independent visual response based on the respective frequency of illumination by the reader. Again, the selection of such components is within the ability of one of ordinary skill in the art.

Thus, encryption within the tagging material (over and above that which is discernable by the human eye) is possible. Accordingly, when viewed under one wavelength of light, one portion of the tagging material may be illuminated due to a response thereto. When viewed under a different wavelength of light, a second portion of the tagging material becomes illuminated. Indeed, multiple superimposable images may result from illumination under different light scenarios. Multiple indicia/codes may thus be incorporated into the same tagging material.

The fluorescence material and the consequential exciting frequency can be modified, either as a function of the fluorescing material excitation characteristics, or the design pattern using the same frequency series combinations to provide an almost infinite combination of tagging material designs, as well as tagging material responsiveness. Such an embodiment differs from prior art approaches, as there can be provided simultaneous, super-imposable alpha/numeric indicia which can be visualized independently based on the frequency of the illuminator which is used for authentication.

For instance, multiple alphabet characters may be provided within the filament, and corresponding, within the cross-section of the cut tagging material formed therefrom as shown in FIG. 1, together with a design which may provide additional verification means.

Each alphabetic character may also, for example, be formed by respective pixels comprised of a polymer compounded with a frequency-specific fluorescing agent—for example, a fluorescing agent that excites at 250 mm wavelength. Such characters can co-exist with alphabetic characters formed from a polymer that is compounded with a fluorescing agent that excites at 280 mm, as well as with characters formed from a polymer that is compounded with a fluorescing agent that excites at 310 mm, as well as with characters that excite at 365 mm. In essence, four separate indicia can be provided, with each indicia only becoming visible when viewed under the appropriately-corresponding light source. In this manner, four separate levels of security are provided.

The choice of a specific fluorescing agent, as well as the choice of an appropriate fluorescing light source, is well within the skill of the routineer in the art. For instance, one skilled in the art can readily determine which types of compounding agents will provide the desired fluorescent property at a desired wavelength, as well as select an appropriate light source to achieve the desired fluorescence.

It may further be desirable for the tagging material to have a fixed lifespan, such that, after a pre-determined period of time, it can no longer be detected in the tagged material, or the detected characteristic changes based on the passage of time. Such an embodiment could be useful in confirming, for example, the shelf-life of a food or pharmaceutical product. For example, UV or oxygen-degradable polymers may be used which, over time and upon exposure to UV or oxygen, degrade and become embrittled. Exemplary polymers which exhibit such properties include but are not limited to polypropylene, polyethylene, polystyrene, nylon, vinyl polymers, etc.

It may also be important to confirm whether the tagged material has been in contact with any portion of the environment from which it is intended to be isolated, such as exposure to UV, radiation, oxygen heat, etc. To the extent that a tagged product is to be isolated from oxygen in the air, a tagging material may be employed that includes a component that is reactive with oxygen such that contact with oxygen could be confirmed by a chemical change in the tagging material (color change, chemical change such as by oxidation, etc.). The tagging material could also include a component that is reactive with moisture, such that contact of the tagged material with moisture (if such a result is deemed undesirable) could be confirmed. In such an instance, the security aspect of the invention is not directed so much toward the source or origin of the tagged material, as toward the safety of the material (especially as to foodstuffs and drug or pharmaceutical compositions). The identity of such types of reactive materials would be known to one of ordinary skill in the art. Exemplary polymers which may be used for such purpose (i.e., water reactivity) include but are not limited to polylactic acid, and polyesters having hydrolysable esters.

The tagging material may also exhibit a property that can be determined by conventional analysis, such as radioactivity, luminescence, electrical impedance, fluorescence, etc. Such properties can, of course, be imparted to the tagging material by incorporation of a suitable component if not an inherent property. For instance, a radioactive material (metal or otherwise) can be admixed with a polymeric tagging material to provide a multiple-layered level of security.

As discussed above, the microscopic tagging material of the present invention may be employed in a variety of ways. For instance, to enhance agricultural safety and minimize food safety concerns, the microscopic tagging material of the present invention may be sprayed (such as in aerosol form) or coated, without limitation, onto agricultural products such as leafy plants, vegetables, fruits, seeds, nuts, etc. For instance, such tagging materials may be used with advantage to confirm the authenticity of organic versus non-organic vegetables or fruit, if the organic vegetables or fruit is “tagged” at the farm prior to shipment. U.S. patent publication 2002/0173042 teaches the use of food safe tagging materials, and U.S. Pat. No. 6,406,725 discloses the use of colored plant protein-derived marker pellets in agricultural commodities. However, neither of these disclosures teach the use of informational tagging materials for use with agricultural products as in the present application.

As a result of the ability of such tagging materials to incorporate information within the cross-section, such tagging materials may be encoded in a manner which identifies the geographic source of such products. For example, the tagging material may be encoded with geographic identifiers which identify the specific geographic locale of the farm or manufacturing plant which produces the product. Such code may be numeric (such as longitude/latitude), or alpha-numeric (to denote a plant or batch number). Given such information on the product, it would be simple to determine the source of the product, both by producer as well as by physical locale.

Such information is particularly useful in the event that a specific producer of the agricultural product has several plants or farms which produce the product in question. Indeed, given the ability of the present invention to provide highly detailed information within the tagging material, it is even possible to tag the product with information as specific as the date of harvesting, processing, or manufacture, with a product lot number also being included. The flexibility by which the present invention is able to provide detailed information on the tagging material, the type of identifying information provided on the material is essentially limitless. This aspect of the present invention is particularly useful in connection with “in contact” agricultural products and foodstuffs which are not otherwise processed in a manufacturing plant.

Such advantages also pertain to non-agricultural products as demonstrated in FIG. 1, which depicts a microtag which identifies a drug product by chemical formula, as well as by manufacturing lot number.

1. An extruded filament having a cross-sectional configuration which permits a cut transverse section of said filament to function as a high definition tagging material, said extruded filament having contained therein, along the direction of a longitudinal axis of extrusion of the filament, a multitude of extruded strand portions, which may be the same or different from one another in composition, visual or forensic effect, and which strand portions provide a multitude of pixel-like portions within a cross-sectional portion of the filament, which multitude of pixel-like portions, when taken together, comprise at least one pre-selected degree of identification whereby said tagging material may be differentiated or identified based on said at least one degree of identification.

2. The extruded filament of claim 1, wherein each said pixel-like portion has a maximum dimension of from about 0.0001 to 50 microns.

3. The extruded filament of claim 1, wherein each said pixel-like portion has a maximum dimension of from about 0.001 to 50 microns.

4. The extruded filament of claim 1, wherein at least some of said strands separately comprise different types of polymer.

5. The extruded filament of claim 1, wherein at least some of said strands separately comprise different colors of polymer.

6. The extruded filament of claim 1, wherein said at least one degree of identification comprises a pre-selected indicia which identifies one or more of the manufacturer, source, geographic source or manufacturing information associated with a product.

7. The extruded filament of claim 6, wherein said indicia is alpha-numeric.

8. The extruded filament of claim 6, wherein said indicia comprises words or symbols, or artwork.

9. The extruded filament of claim 1, wherein said strands include at least one of a colorant, a pigment, dye, a forensic agent, a filler, or other indicator agent that permits one or more of said strands to be differentiated from one another.

10. The extruded filament of claim 1, having at least two degrees of identification selected from the group consisting of physical configuration, elemental fingerprinting, functional analysis, and polymeric fingerprinting.

11.-14. (canceled)

15. The extruded filament of claim 10, wherein one of said degrees of identification is capable of FTIR infrared analysis or electron dispersive analysis.

16. (canceled)

17. The extruded filament of claim 10, wherein one of said degrees of identification is by fluorescence, electrical impedance or luminescence.

18.-19. (canceled)

20. The extruded filament of claim 1, having a component that is functionally active and undergoes a physical or chemical change when exposed to a predetermined condition or set of conditions.

21. The extruded filament of claim 20, wherein said functionally active component is visually responsive upon exposure to a predetermined radiation source.

22. (canceled)

23. The extruded filament of claim 1, which comprises from about 2,000 to 150,000 pixel-like portions in a cross-section thereof.

24. The extruded filament of claim 23, wherein said pixel-like portions have a maximum width-wise dimension of about 50 microns or less.

25. The extruded filament of claim 24, wherein said pixel-like portions have a maximum width-wise dimension of 10 microns or less.

26. The extruded filament of claim 23, wherein at least about 5000 pixel-like portions are present in said cross-section.

27. (canceled)

28. A microparticle comprising a transverse section of the filament of claim 1, the section having a maximum dimension across the section in the range of about 100 to 120 microns.

29. A method of marking a product, or a package or container containing such product, for purposes of product authentication, comprising incorporating a microparticle according to claim 28, with said product, on a package containing said product, or on a container associated with said product, wherein said microparticle includes within its cross-sectional area pre-selected identifying, authenticating or informational indicia capable of authenticating said product or providing information in relation to said product.

30.-34. (canceled)
